(19) United States
(12) Patent Application Publication
(10) Pub. No.: US 2021/0149345 A1
(43) Pub. Date: May 20, 2021

(54) A HYBRID MECHANICAL SMART TIMEKEEPER SUCH AS A WATCH

(71) Applicant: Julien SZULEWSKI, Lausanne (CH)

(72) Inventor: Julien SZULEWSKI, Lausanne (CH)

(21) Appl. No.: 17/254,639

(22) PCT Filed: Jun. 21, 2019
(86) PCT No.: PCT/IB2019/055254

§ 371 Date: Dec. 21, 2020

(30) Foreign Application Priority Data
Jun. 22, 2018 (CH) 00795/18

(51) Int. Cl. G04C 17/00; G04G 9/00; G04G 21/08; G04G 21/02; G04G 17/04; G04G 21/04

(52) U.S. Cl. CPC G04C 17/0041; G04G 9/0064; G04C 17/0091; G04G 21/04; G04G 21/02; G04G 17/045; G04G 21/08

(57) ABSTRACT

The hybrid timekeeper, such as a watch, comprises a classical part with at least a mechanical movement with hands to indicate a time measure on a dial, a crown and a rotating winding mass, and a smart module, both classical part and smart module being combined in a same watch case. The timekeeper in combination with a portable phone can be the parts of a general communication ecosystem.

### CORRESPONDING APPLICATION

The present application claims priority to the earlier Swiss patent application No 00795/18 filed on Jun. 22, 2018 in the name of Julien SZULEVVSKI, the content of this earlier application being incorporated by reference in its entirety in the present application.

### TECHNICAL FIELD

The present invention concerns the field of timekeepers such as watches or other similar products.

More specifically, the present invention concerns a timekeeper such as a wristwatch which has both a mechanical movement to measure/display time and smart capabilities to display and use applications that are common nowadays in the field of smart devices such as smart watches.

The present invention forms a full and real hybrid device such as a watch using at the same time traditional watchmaking technology and cutting edge modern technology together to create an improved object over the prior art.

The present invention also creates a new and original ecosystem of products and functions for the benefit of its user.

### BACKGROUND ART

Classical watches and timekeepers with a mechanical or a quartz movement have been known for many years in the field of horology. Historically, the first timekeepers/watches used mechanical movements to measure time. Then, with technology progress, quartz operated timekeepers and watches became popular in the 80's and also devices with digital displays to replace the hands and dials. However, the market is still strong for classical watches with hands and a dial to measure and indicate time, date or to measure time (such as in a chronometer). Especially for watches and timekeepers of a certain (high) price, such as luxury products or manufactured by companies showing a long tradition of watchmaking, a mechanical movement is an essential part of such watches and timekeepers. On the market, such watches are always sought after, some being even real pieces of art.

In the other hand, with the actual technological progress, so called “smart watches” are becoming more and more popular and such watches using state of art electronics, the internet of things (IOT) and modern applications allow their users to benefit from many applications that are now present in mobile smart phones, in the cloud, on the smart watch and IOT.

Technology progress now also allows a pairing and a wireless connection between a smart watch and a smart phone (an object that has now become a standard tool for daily use and has open an near infinite possibility of functions and data gathering/treatment) which have nothing to do with measuring time per se. Typical recent products include, for example, the Apple Watch™ developed by the company Apple™ which allows its user to access numerous applications, such phone, calendar, internet, GPS, payment, health related applications etc. at its wrist.

Many other companies propose other similar products, for example in the field of sports to track the physical activity of the wearer and other parameters (position, speed, distance, personal data as heartbeat etc.).

In the future, this trend will most probably not decline: rather the interconnection between objects of our current life will increase thus bringing a transformation in our society and in our relation to the objects present in our environment.

All these devices (classical watches and smart watches) have their aficionados but there is also an interest in proposing devices using the best of both worlds, one of tradition and another one of cutting edge modern technology.

One of the problem a user is confronted with when using a smart watch is the recharging of energy. If technology has really been developed today for smart devices (such as smart phones, electrical cars and other similar devices), a weakness of all these modern devices is the electrical energy they use and the necessity to regularly recharge their electrical accumulator with energy. In addition, considering the limited space that is available is some of these devices, the energy source (battery, accumulator) also has a limited capacity.

Actual smart watches have usually to be placed on a support that produces such electrical energy for the accumulator. However, the user needs to carry around the necessary hardware for this operation (cables, base etc. . . . ), items that are typically forgotten when traveling or lost over time. Also, in some environments, for example when practicing sports, hiking etc. electrical energy is simply not available unless the wearer carries specific equipment (booster batteries, solar cell devices etc) all being bulky and heavy.

Another problem is linked to the use of a smart parts in a watch is that, for example, they cannot be repaired easily or the cost of a reparation is too high. If mechanical watches may be repaired (if this is acceptable on an economical level), the smart parts of a smart watch are usually not repairable and such a watch is thrown away in case of a problem. It is therefore necessary to be able to replace this part.

Also, in the field of electronic devices, with the progress of technology, users are incited to change their devices (for example their portable phone, or computer or watch) on a regular basis because their obsolescence make them unfit for new versions or updates of programs/applications that are proposed to the users. If it is usually possible to make a certain number of updates with a given device, there is always a moment in time (for example after two or three years) when it becomes necessary to exchange said device for a new one incorporating all the most recent technical features (for example microprocessors, memory, operating systems) and applications. This problem is also linked to the limitation of storage capacity of devices (the need for storage space increases with technology progress) and the ageing of the components, typically the battery of the devices which decline in performance over time and charging cycles.

For a watch as in an embodiment of the present invention, there is an opposition between a traditional part which is to be kept unchanged for many years and a modern part that has a shorter life duration.

### SUMMARY OF THE INVENTION

An aim of the present invention is therefore to propose improved products over the ones known in the prior art.

A further aim of the present invention is to provide an improved timekeeper, such as a watch, that at the same time has a traditional aspect and a modern aspect, both being also used in combination together, where the two aspects do not limit each other.

A further aim of the present invention is to mix traditional technology with modern technology, each technology being beneficial to the other.

An idea and contribution of the present invention is to construct an ecosystem and a community based on a product, in examples described herein a smart watch, to create new, modern and futuristic experiences for users of the product, within the actual and future technology and art of life trends. An example of this eco-system is given in FIG. 9 and discussed hereunder.

The watch is at the center of the system and is used for many aspects and features. It is preferably the slave of a portable phone (or another similar device) and used in combination with it, the watch containing the necessary technological features and capabilities in a smart module.

For example, as features, data and experiences of the proposed ecosystem, the following are possible:
The watch may be used to sense and monitor body signs (heartbeat, temperature, blood pressure and other measurable parameters of the wearer etc. . . . ) of the wearer to be used in dedicated applications and give some defined/desired information to the wearer or to an application on the phone, or in a network (internet, cloud etc. . . . ). The network may be linked to health linked capabilities (for example patient files, monitoring of some parameters, prevention or emergency alert in case of detected health problem of the wearer etc.)
The watch may be used to display or react to information from the phone, for example reminders, deadlines, meetings, incoming emails, news, etc. . . . any information desired by the user and for example configured in applications (“apps”) of the phone.
The watch may be used as a payment means/terminal, for example by using NFC technology or another equivalent communication technology, thus replacing the physical cards (such as credit cards or debit cards, membership cards, loyalty cards, gift cards etc. . . . ) of the user by an electronic version of said cards.
The watch may be used in a more general context of IoT (“internet of things”) to connect the user to other products of the current life, such as a car, home appliances and automation (lighting, heating etc.), travel applications (tickets for flights, train, access to reserved places, such as rooms, concerts, lounges, fairs, trade shows etc. . . . ), replacement for physical cards (credit, gift, loyalty etc.).
The watch may be used for geolocalization, tracking, route planning and displacement/journey analysis, sports etc.

As a further application, the watch may be used to create a new community experience between wearers of the same watch or of the same brand (or another associated brand). To this effect, a recognition feature/app is installed and allows a wearer to detect a proximity (such as a physical proximity) with another wearer of the same watch, or a watch of the same brand (or even another brand but with a corresponding feature/app) so that wearers may enter in contact personally as soon as this proximity has been detected. This can be done by geolocalization (for example in the phones of the wearers, or in the cloud or another place with appropriate upload and download of data) or close communication (Wifi, NFC, Bluetooth and other equivalent technologies) between the devices (phones, watches etc.). This feature may be based on a physical proximity only (when the wearers are close to each other) and/or on other parameters, such as attendance to a same event, journey, or common tastes (such as music, food, beverages) and/or hobbies and/or activities (including professional activities), or origin, beliefs, personal orientations and status etc. Many possibilities exist based on the personal information and data a wearer is ready to share in a community.

Of course any feature may be disabled by the user if not desired (temporarily or permanently).

All these functions and features, including other equivalent ones, are made possible by the use of the smart part of the product (i.e. watch) preferably paired with a portable phone and these are examples of possible embodiments, not to be regarded as limiting.

In an embodiment, the invention concerns a hybrid timekeeper, such as a watch, comprising a classical part comprising at least a mechanical movement with hands to indicate a time measure on a dial, a crown and a rotating winding mass, said timekeeper further comprising a smart module with electronical components, both classical part and smart module being combined in a same watch case, the module being removably inserted in the case and providing smart capabilities to the timekeeper.

Preferably, in an embodiment, the hybrid timekeeper communicates wirelessly via its module with a smart phone. For example, they may be connected together such as paired.

In an embodiment, the module is used to carry out at least some or all these functions:
to sense and monitor body signs or to display, and/or to react to information/data received from a source, such as a portable phone, for example reminders, deadlines, meetings, incoming emails, news,
and/or as a payment means/terminal, for example by using NFC technology or another equivalent communication technology,
and/or in a more general context of IoT (“internet of things”) to connect the user to other products of the current life,
and/or to create a new community of experiences between wearers of the same watch or of the same brand or another associated brand.

In an embodiment, applications are installed at least in the phone to carry out the said functions. They may be only installed in the phone or only partially and/or also partially or entirely installed in the timekeeper.

In an embodiment, a recognition feature/app allows a wearer to detect a proximity with another wearer of the same timekeeper, or a timekeeper of the same brand (or even another brand but with a corresponding feature/app) or a wearer just using the same feature/app but with a different timekeeper so that wearers may enter in contact personally as soon as a proximity (such as a physical proximity) has been detected.

In an embodiment, the recognition may be done by geolocalization (for example in the phones of the wearers, or in a “cloud” or another place with appropriate upload and download of data) or close communication such as wifi, NFC, Bluetooth and/or another equivalent communication technology between the devices.

In an embodiment, the smart part comprises at least charging means to produce electrical energy to be stored in an accumulator of the timekeeper and displaying means.

In an embodiment, the charging means comprises a microgenerator system and/or an induction system.

In an embodiment, the microgenerator system uses a dedicated rotating mass and/or the rotating mass of the mechanical movement and/or the actuation of the crown of the timekeeper.

In an embodiment, the displaying means comprise at least a touchscreen.

In an embodiment, the displaying means comprise at least a display on the module.

In an embodiment, the displaying means comprise at least a display at the dial level or on the dial.

In an embodiment, the display covers the entire dial or only a part of the dial.

In an embodiment, smart functions are controlled by the crown and/or a bezel of the watch for example. Other means may be installed and/or used for this purpose.

In an embodiment, the timekeeper is a watch, such as a wristwatch.

In an embodiment, the invention concerns a communication eco-system using at least a timekeeper as defined in the present application with at least a portable phone (such as a smart phone) or other equivalent devices (tablet etc.).

In an embodiment, the invention concerns a method of using a hybrid timekeeper and/or an eco-system as defined in the present application.

In embodiments, the method of use may be to create a new community of experiences between wearers of the same watch or of the same brand or another associated brand, whereby said wearers connect for common or shared interactions, such social contacts, exchanges, meetings, common interests etc.

In embodiments, the method of use may be, as examples,

to sense and monitor body signs or to display such signs or a information based on/derived from said signs,
and/or to react to information/data received from a source, such as a phone (smart phone), for example reminders, deadlines, meetings, incoming emails, news,
and/or as a payment means/terminal, for example by using NFC technology or another equivalent communication technology,
and/or in a more general context of IoT (“internet of things”) to connect the user to other products of the current life (home appliances for example and other connected products with IoT capabilities).

Non-limiting embodiments and non-limiting examples of the present invention are now described in more detail with reference to the drawings.

### DESCRIPTION OF THE DRAWINGS

FIG. 1 illustrates a schematical back view of an embodiment of the present invention;

FIG. 2 illustrates a schematical back view in perspective of an embodiment of the present invention;

FIG. 3 illustrates a schematical back cut view in perspective of an embodiment of the present invention;

FIG. 4 illustrates a schematical front view of an embodiment of the present invention;

FIG. 5 illustrates a schematical front view in perspective of an embodiment of the present invention;

FIG. 6 illustrates a schematical front cut view in perspective of an embodiment of the present invention;

FIG. 7 illustrates embodiments of the present invention;

FIG. 8 illustrates bloc-diagrams of embodiments of the present invention.

FIG. 9 illustrates an example of an eco-system according to the present invention.

### DETAILED DESCRIPTION OF THE INVENTION

For the sake of clarity, a timekeeper according to the present invention has been named or is named, in embodiments, “smart watch” or “hybrid smart watch” or “hybrid watch” or simply “watch” in the present specification, with no limiting intention, as the principles of the present invention are applicable to other similar devices such as timekeepers and other time measuring means and devices. Also other similar products are also envisaged and encompassed in the frame of the present specification.

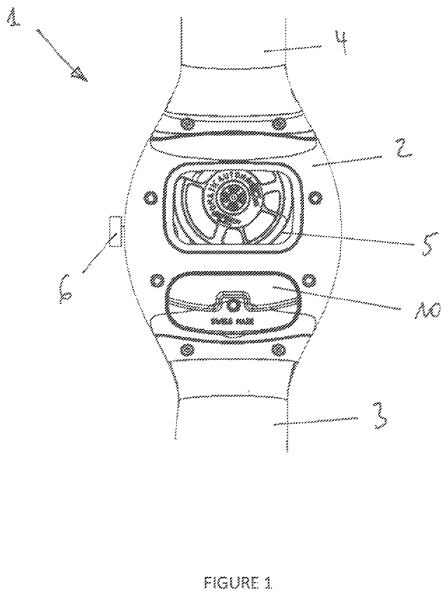

An embodiment of the present invention is illustrated in FIG. 1 which shows the back of the case 2 of a wristwatch 1 to be worn on the arm of a user.

The watch comprises in a general manner the case 2 and two parts 3, 4 of a strap for attachment to the wearer. Preferably, the strap parts 3 and 4 are easily exchangeable, for example to be able to personalize the watch and its appearance or to follow a trend, or to illustrate an event (such as a sports competition, a concert, a social event, an historical date etc. . . . ).

The case 2 further comprises a window 5, preferably transparent, through which one may see the mechanical movement of the watch, or parts of it, said mechanical movement being used for marking or indicating the time of the day with appropriate hands as is known in the field of mechanical watch making, and an electronic (or smart) module 10, a description of which being given later in the present description. The watch also comprises a crown 6 as is known in the art.

Typically, the “classical” part of the watch 1 comprises the mechanical movement (automatic or manual) for displaying the time of day as is well known in the art.

According to embodiments of the present invention, the watch is a smart watch that not only includes this mechanical part of a watch but also a smart module (i.e. an electronic module) 10 dedicated for smart functions as described herein thus providing many improvements and additional features and functions to a timekeeper according to the present invention.

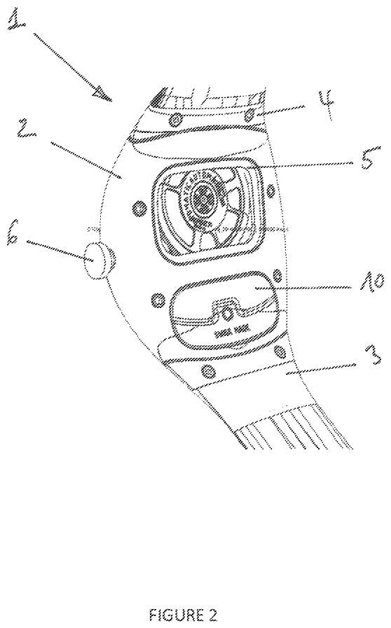

FIG. 2 illustrates the watch in a side perspective view with the same elements identified by the same references as above.

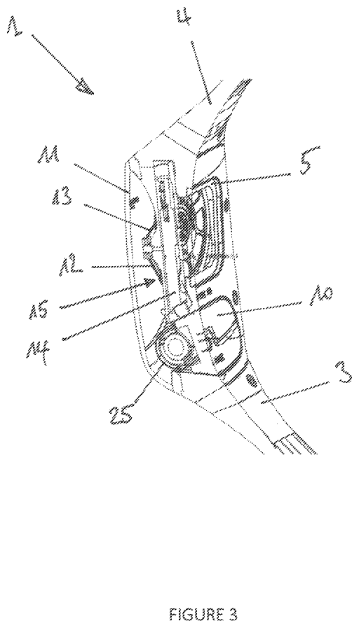

FIG. 3 illustrates the watch in a side perspective view with same elements identified by the same references as above but being cut to better illustrates the inner arrangements of the parts. The watch thus comprises a glass 11 and hands 12 (hours), 13 (minutes) and 26 (seconds) to indicate the time of the day (or night) on its front side. The glass 11 and 25 (glass of the module 10) may be a normal transparent glass (made of any suitable material) or a transparent, tinted or colored touchscreen OLED, AMOLED, TFT, electronic paper (“E-Paper”) as known in the field of displays in some embodiments of the invention. The interest of E-paper is its low electrical consumption but of course this is an example and other constructions and materials are possible in the frame of the present invention.

Reference 15 designates the dial of the movement.

Reference 14 designates in a general manner the mechanical part of the watch that is classic in the art of watchmaking, known in the art and thus not described in more detail here. It can be manual winding mechanism or an automatic one.

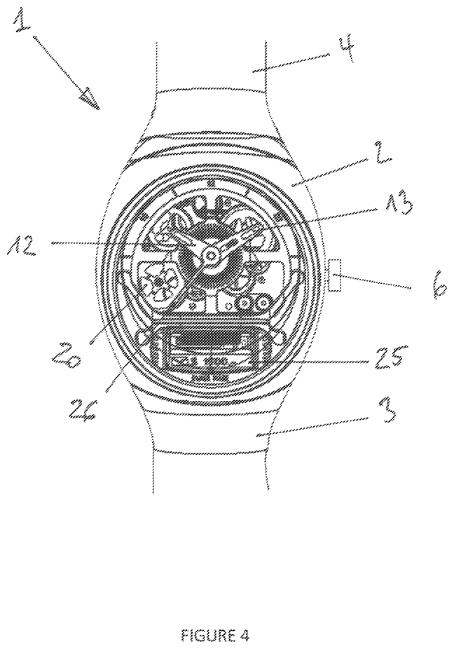

FIG. 4 illustrates a front view of a timekeeper according to an embodiment of the present invention with the references detailed above. On this figure is also illustrated element 20 which is a microgenerator used to generate electrical energy, for example by cooperation with the winding mechanism of the timekeeper.

The hybrid watch according to the present invention, in addition to the classical mechanical watch described hereabove, comprises a smart part 10 (e.g. digital means) integrated in the watch case 2 that comprises preferably at least the following elements/means, all described in the course of the present description:
a digital screen 25 that may replace at least partially the dial 15 or form a part thereof;
the front glass 11 and 25 of the watch may include touchscreen and display capabilities;
a micro generator 20 (for example: Kinetron System™) system to generate electrical energy;
an electrical accumulator 21 (or battery) to store electrical energy;
an induction system or means and capability to charge the accumulator with energy.
a long range wireless power to charge the accumulator (named Qi)
receiving and emitting capabilities (NFC, wifi, Bluetooth etc. . . . ) to be able to communicate with a phone, with readers and terminals, with a distant web, such as the internet, all these accesses being either directly or through a phone.

Accordingly, in embodiments of one aspect the present invention, the hybrid smart watch may comprise or use a plurality of means (such as sources of energy) for charging an electrical accumulator.

One source may be a Kinetron™ system (see the website http://www.kinetron.eu/for information about this technology) or a Kinetron-like system that generates electrical energy with movement. As known, the Kinetron™ system comprises a moving mass and microgenerators 20 that produce electrical energy by the movement of the mass. To this effect, a dedicated mass may be used to act on the generators, the dedicated mass being moved by the movements of the wearer of the watch. Alternatively, one may also use the rotating mass of the winding system of the mechanical watch or both masses (the dedicated one and the one of the winding system) to sollicitate the Kinetron™ system and generate electrical energy.

In another embodiment, the Kinetron™ system or its equivalent may also be sollicitated by rotating the crown 6 of the watch that also will rotate the generators and thereby produce electrical energy. For example, the placement of the crown 6 in a dedicated position (for example by pushing) may be used as the trigger for the energy production by rotation of the crown 6.

The movement may also be a displacement of the wearer (for example by walking) or another action of the wearer that may be converted in electrical energy.

All these solicitations may be carried out independently or in a combined manner to produce electrical energy that will be stored in the accumulator of the watch. Accordingly, one hybrid watch or device according to the invention may use one principle or another or all to generate energy.

In another embodiment, the energy charging may be done via induction means with a wireless charger (long range or short range). This way may be combined with the other systems and principles described above to provide an efficient system relying on different sources to produce energy.

In an embodiment, the front glass 25 of the module comprises display means/capabilities (for example by way of E-Paper screen) in order to propose applications and/or information/data to the wearer of the watch. Typically, the selection of an application may be driven by the crown 6 placed in a dedicated position (for example by pushing the crown 6 and then rotating it to show the possible applications) and validating the choice (for example by pressing on the crown). Of course, applications may be preinstalled in the watch or downloaded later from a dedicated place (for example a website), preferably applications are located on a portable phone of the wearer which then transmits or receives the information/data to or from the module 10. The glass 11 has a touch control technology being formed as a touchscreen, and it is possible then for the user to monitor or access the chosen application directly by touching the glass 11 of the watch and to launch said application or access to different pages/windows/levels of the application.

As another display, the watch may comprise a digital screen (for example TFT display) that is at the level of the dial 15 of the movement. This screen may be used to show information, for example linked to applications of the watch (the applications are in the cloud (wireless server) or mainly in the smart phone computer but preferably not in the watch. The watch is a companion or a slave and communicates via wireless and contact. Both displays (the one of the front glass and the one of the dial) may be used in the same watch, or they may be alternative, proposed in different models (i.e. embodiments) of the watch. If they are used together, they may propose independent information or linked information or a partial information.

As said above, the crown 6 may be used to firstly act on the hands 12-13 to adjust the time, but also to generate energy and to navigate between application (or even in a given application) by its rotation. Preferably, the dedicated position to carry out one of these functions is determined by the position of the crown 6, for example by pushing and/or turning the crown 6. Other ways are possible, for the example by the turning direction of the crown 6, depending on its position.

For example:
A position is used to manage the mechanical functions of the movement.
A position is used to charge manually the battery for the smart module thanks to the Kinetron or equivalent system. Typically, 30 seconds will produce 1 day of energy.
A position is used to manage the smart module with apps on the screen (of the watch and/or of the module).

Other positions may be envisaged to add other functionalities and/or management capabilities.

Many variants are possible. Also, another part of the watch may be used to this effect, in combination with the crown 6 or not, for example a watch bezel, or additional buttons on the watch case. Accordingly, it is possible to provide several possibilities to create definite actions on the watch, for example to choose applications or navigate within them etc. . . .

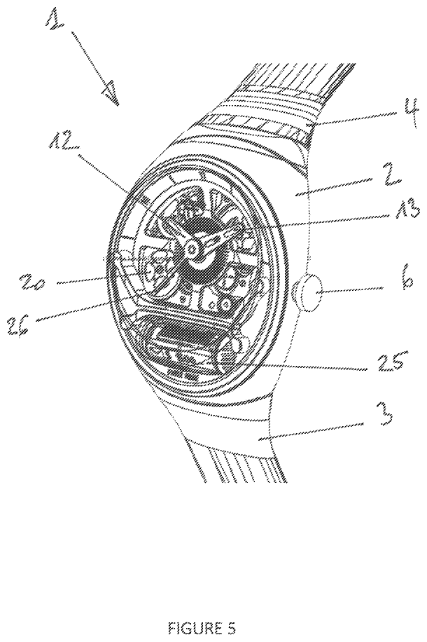

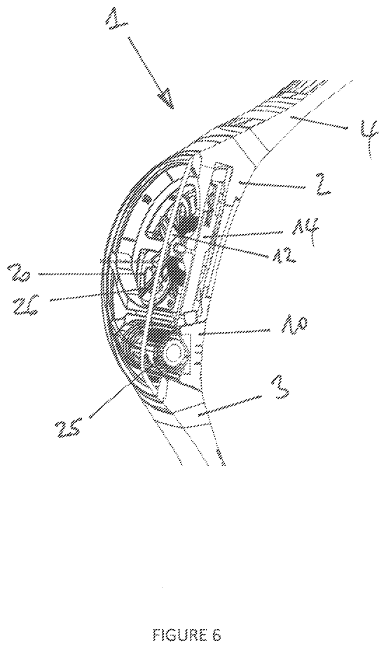

FIGS. 5 and 6 illustrate front view and side perspective view of a watch according to an embodiment with the same elements identified with the same references as in the preceding drawings.

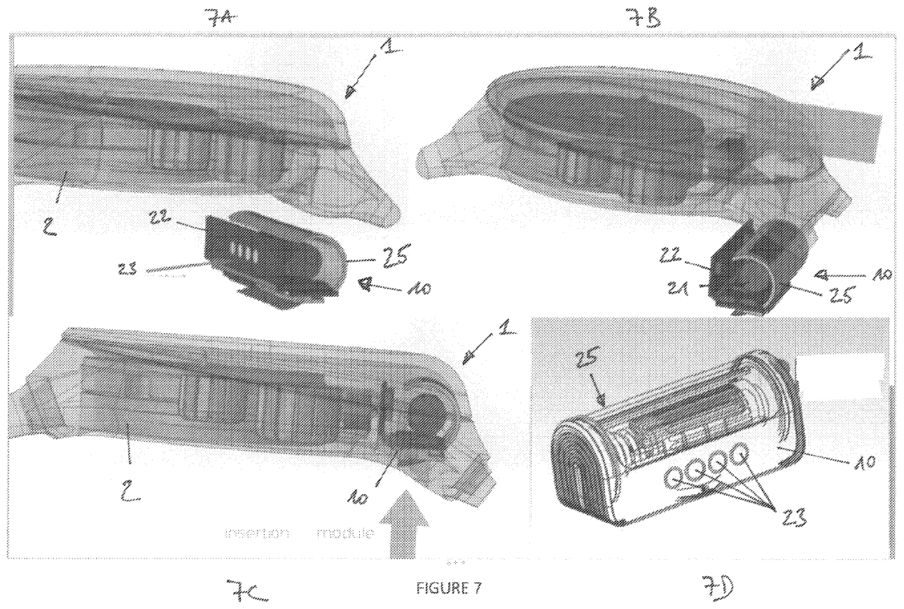

FIG. 7A to 7D illustrate perspective views of a module according to an embodiment of the present invention.

The module 10 comprises at least an accumulator 21 for electrical energy, such as a rechargeable battery, a PCB 22 (printed circuit board) with the electronics used for the electronic parts of the watch (chip etc. as is known in the art). All the electronic parts are connected and communicate as desired as is known in the art of electronics and smart products. The accumulator 21 may be present in the module 10 only, or in the watch 1, or distributed in both.

The module also comprises contacts 23 for electrical contact with the components of the watch 1. FIGS. 7A and 7B illustrate the module 10 which is not inserted in the watch case 2. FIG. 7C illustrate the module inserted in the watch case 2. FIG. 7D illustrates the module alone in a perspective view.

In further embodiments, the touch screen 25 of the module 10 may be independent from the watch and provide access to applications stored in the watch or accessed via wireless technology or it may complement the watch function in providing additional information (such as date, reminders of action stored in a dedicated schedule etc. . . . as described herein).

The combination of all these technical features thus allows a wearer to use in the same device a traditional part of a watch and modern features, both worlds thus coexisting in a same device and complementing each other.

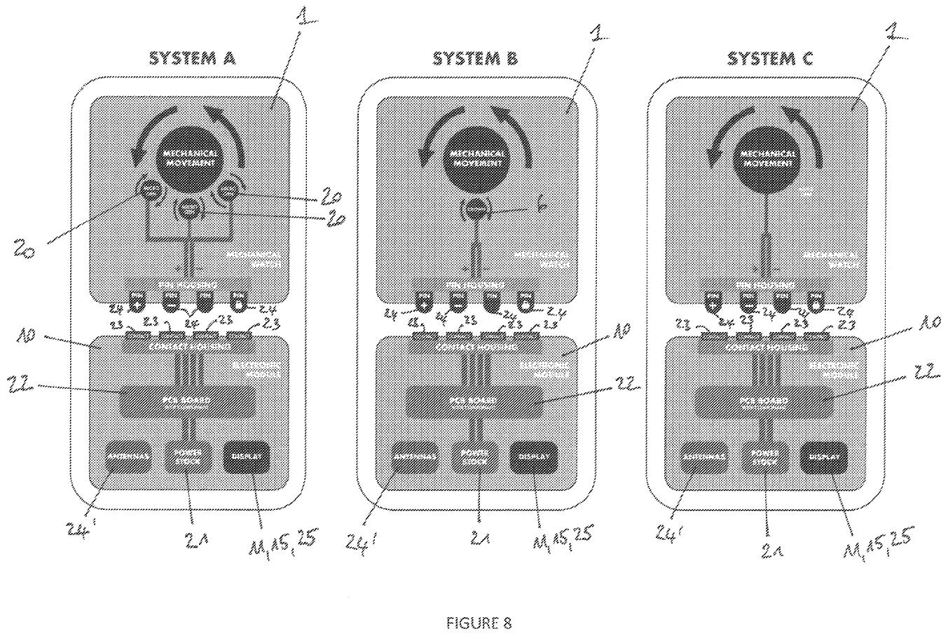

FIG. 8 illustrates block drawings (“system A”, “system B”, “system C”) of possible embodiments of the invention.

In all systems, the module 10 is connected to the watch 1 by the contacts 23 (on the module side) and 24 (on the watch side), the module comprises the power accumulator 21, the PCB 22 and possibly an antenna 24′ (or several antennas, for example adapted to frequency and/or to use, for example WiFi, NFC and other close and distant communications channels and means therefor).

Preferably, the module 10 is fixed to the watch once inserted via means that allow a stable position and an exchange of the module: for example a screw or another equivalent means, a key, a snap-like system etc. . . .

Also the module 10 and the watch 1 are waterproof at least when assembled. This may be achieved by the use of sealing means, such as an O-ring, gasket/seals as are common in the field of watchmaking for example.

On the watch side, each system illustrates a possible way of generated electrical energy for the smart part:
System A uses microgenerators (such as 20), which are actuated by the rotation of the mechanical part (for example its winding means)
System B uses the crown 6 as generator of electrical energy
System C uses directly the rotation of the mechanical parts.

Of course, each of these systems may be used alone or in any combination in the present invention. Other equivalent system may be used as well to achieve this goal of provision of electrical energy to the watch.

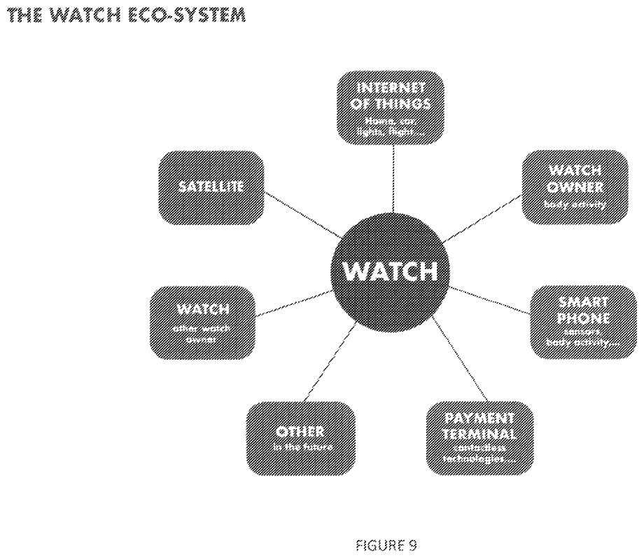

An example of an eco-system according to the present invention is illustrated schematically in FIG. 9 with blocs showing functions, as described in the present application hereabove. For example, the timekeeper (watch 10) is at the center of the eco-system and preferably connecter/paired with a portable phone of the wearer of the timekeeper.

Starting from the top block (“at 12”), the watch may be immersed and used in an Internet of things (IoT) system for communication with other “things” such as objects as discussed above, such as a car, home appliances and automation, travel applications (tickets etc. . . . ), replacement for physical cards etc. . . .

The next blocs are discussed clockwise.

The second bloc (Watch owner”) indicates the capabilities of managing watch owner/user data, such as body activity and other body or health parameters discussed herein.

The next block (“Smart phone”) indicates the smart phone relation/exchanges and capabilities.

The next block (“Payment terminal”) indicates the terminal and payment capabilities of the watch.

The next block (“Other”) indicates other function that will possible in the future based on technology progress and consumer wishes and needs.

The next block (“Watch”) indicates the interaction possibilities with other identical or similar watch owners (social contact and exchanges, meeting etc. . . . ).

The next block (“Satellite”) indicate the interaction possibilities and uses in relation to satellites (for example geolocalization, route/trip planning, and other communication possibilities using a satellite).

Of course, all these examples are non-limiting possibilities and others are also within the frame of the present invention.

The present invention and technology is a true hybrid mecha-smart device. It may work with the energy produced naturally by the watch's wearer during his daily business. It is an automatic watch that feeds an intelligent digital display. Technically, the active movement of the oscillating wrist/rotor assembled with several micro-generators do the job, plus an optional wireless induction charge in order to be sure to be switched on during at least all day. This purely mechanical process allows electrical energy to continuously feed the smart digital capabilities of the device and the backlit E-Paper or LED pattern) (and/or TFT) electronic smart module.

Of course, the timekeeper according to the present invention also comprises communication means, for example antenna means for a wireless communication with a network, for example the internet for up and downloading of data, information, updates and applications and for carrying out the desired functions described herein. This exchange may also be carried out by other appropriate and/or equivalent technical means (wire, docking station, induction, NFC etc.).

The embodiments described in the present application are illustrative examples and should not be regarded as limiting. Many variants of a timekeeper are possible using different technical features in combination are possible. Also, equivalent means may be used without departing from the spirit and scope of the present invention.

If examples of the present specification relate to a watch (or a wrist watch), the principles of the invention are of course applicable to other devices with no limitation. In addition, the object, for example the watch may also be used without the smart part, i.e. without the module 10, as a normal mechanical watch. In such case, the smart function will simply not be activated but the watch will retain its initial function of indicating time.

1. A hybrid timekeeper, such as a watch, comprising a classical part comprising at least a mechanical movement with hands to indicate a time measure on a dial, a crown and a rotating winding mass, said timekeeper further comprising a smart module with electronical components, both classical part and smart module being combined in a same watch case, the module being inserted in the case and providing smart capabilities to the timekeeper.

2. The hybrid timekeeper of claim 1, wherein said timekeeper communicates wirelessly via said module with a smart phone.

3. The hybrid timekeeper of claim 1, wherein said module is used
to sense and monitor body signs or to display,
and/or to react to information/data received from a source, such as a phone, for example reminders, deadlines, meetings, incoming emails, news,
and/or as a payment means/terminal, for example by using NFC technology or another equivalent communication technology,
and/or in a more general context of IoT (“internet of things”) to connect the user to other products of the current life,
and/or to create a new community of experiences between wearers of the same watch or of the same brand or another associated brand.

4. The hybrid timekeeper of the claim 1 wherein applications are installed at least in the phone to carry out the said functions.

5. The hybrid timekeeper as defined in claim 3 wherein a recognition feature/app allows a wearer to detect a proximity with another wearer of the same timekeeper, or a timekeeper of the same brand (or even another brand but with a corresponding feature/app) so that wearers may enter in contact personally as soon as a proximity has been detected.

6. The hybrid timekeeper as defined in claim 1 wherein this can be done by geolocalization (for example in the phones of the wearers, or in the cloud or another place with appropriate upload and download of data) or close communication such as wifi, NFC, Bluetooth and/or another equivalent technologies between the devices.

7. The hybrid timekeeper of claim 1, wherein the smart part comprises at least charging means to produce electrical energy to be stored in an accumulator of the timekeeper and displaying means.

8. The hybrid timekeeper of claim 1, wherein said charging means comprises a microgenerator system and/or an induction system.

9. The hybrid timekeeper of claim 1, wherein the microgenerator system uses a dedicated rotating mass and/or the rotating mass of the mechanical movement and/or the actuation of the crown of the timekeeper.

10. The hybrid timekeeper of claim 1, wherein the displaying comprise at least a touchscreen.

11. The hybrid timekeeper of claim 1, wherein the displaying means comprise at least a display on the module.

12. The hybrid timekeeper of claim 1, wherein the displaying means comprise at least a display at the dial level.

13. The hybrid timekeeper of claim 1, wherein the display covers the entire dial or only a part of the dial.

14. The hybrid timekeeper of claim 1, wherein smart functions are controlled by the crown and/or a bezel.

15. The hybrid timekeeper of claim 1, wherein the timekeeper is a watch, such as a wristwatch.

16. A communication ecosystem using at least a timekeeper as defined in claim 1 with at least a portable device, such as a phone.

17. A method of using a hybrid timekeeper as defined in claim 1.

18. The method as defined in claim 17, wherein the timekeeper is used to create a new community of experiences between wearers of the same timekeeper or of the same brand or another associated brand, whereby said wearers connect for common interactions, such social contacts, exchanges, meetings.

19. The method as defined in claim 17, wherein the use is to sense and monitor body signs and/or to display such signs or information related to such signs.

20. The method as defined in claim 17, wherein the use is to react to information/data received from a source, such as a phone.

21. The method as defined in claim 17, wherein the use is as a payment means/terminal.

22. The method as defined in claim 17, wherein the use is in a context of IoT (“internet of things”) to connect the user to products of the current life.
